(19) United States
(12) Patent Application Publication
(10) Pub. No.: US 2013/0335994 A1
(43) Pub. Date: Dec. 19, 2013

(54) ILLUMINATED ACCESSORY UNIT

(71) Applicant: Innotec Corp., Zeeland, MI (US)

(72) Inventors: Jason R. Mulder, Zeeland, MI (US); Justin Philip Boetsma, Zeeland, MI (US)

(21) Appl. No.: 13/917,437

(22) Filed: Jun. 13, 2013

Related U.S. Application Data
(60) Provisional application No. 61/659,254, filed on Jun. 13, 2012.

(51) Int. Cl. F21V 9/00; F21V 8/00

(52) U.S. Cl. CPC F21V 9/00; G02B 6/0096
USPC 362/555; 29/592.1

(57) ABSTRACT

A lighted assembly includes a LED that emits light at a first frequency. The lighted assembly further includes an elongated light transmitting assembly having at least one illuminated area, and a non-illuminated area surrounding the illuminated area. The elongated light transmitting assembly includes a cover member on the outer side, a backing member on the inner side, and an intermediate member disposed between the cover member and the backing member. Light from the LED is transmitted along an optical path to the illuminated area. A layer of photo reactive material is disposed along the optical path. The photo reactive material produces light at a second frequency that is lower than the first frequency and provides a mixed light having a required color.

### CROSS REFERENCE TO RELATED APPLICATIONS

This application claims the benefit of U.S. Provisional Application No. 61/659,254 filed on Jun. 13, 2012, entitled, ILLUMINATED ACCESSORY UNIT, the entire contents of which are incorporated herein by reference.

### SUMMARY OF THE INVENTION

One aspect of the present invention is a lighted assembly including an LED that emits light having a first frequency. The lighted assembly further includes an elongated light transmitting assembly defining inner and outer sides. The outer side defines at least one illuminated area having a predefined shape, and a non-illuminated area surrounding the illuminated area. The elongated light transmitting assembly includes a cover member on the outer side, a backing member on the inner side, and an intermediate member disposed between the cover member and the backing member. The LED is optically connected to the elongated light transmitting assembly whereby light from the LED is transmitted along an optical path defined by the elongated light transmitting assembly to the illuminated area. Photo reactive/photoluminescent material is disposed along the optical path. The photo reactive/photoluminescent material produces light having a second frequency that is lower than the first frequency. Light at the first and second frequencies is mixed to provide light having a color that is different than the light emitted by the LED the mixed light is emitted from the illuminated area. Different types of photo reactive/photoluminescent materials may be utilized to form illuminated areas having different colors.

### BRIEF DESCRIPTION OF THE DRAWINGS

FIG. 1 is an exploded isometric view of a lighted assembly according to one aspect of the present invention;

FIG. 2 is a cross sectional view of the lighted assembly of FIG. 1;

FIG. 3 is an exploded isometric view of a lighted assembly according to another aspect of the present invention;

FIG. 4 is an exploded cross sectional view of the lighted assembly of FIG. 3;

FIG. 5 is a cross sectional view of the lighted assembly of FIG. 3;

FIG. 5A is a cross sectional view of the lighted assembly of FIG. 5 taken along the line VA-VA;

FIG. 6 is a cross sectional view of a lighted assembly according to another aspect of the present invention;

FIG. 7 is a cross sectional view of a lighted assembly according to another aspect of the present invention;

FIG. 8 is a cross sectional view of a lighted assembly according to another aspect of the present invention;

FIG. 9 is a cross sectional view of a lighted assembly according to another aspect of the present invention;

FIG. 10 is an exploded isometric view showing assembly of a lighted assembly according to one aspect of the present invention; and

FIG. 11 is an exploded isometric view showing assembly of a lighted assembly according to another aspect of the present invention.

### DETAILED DESCRIPTION OF THE PREFERRED EMBODIMENTS

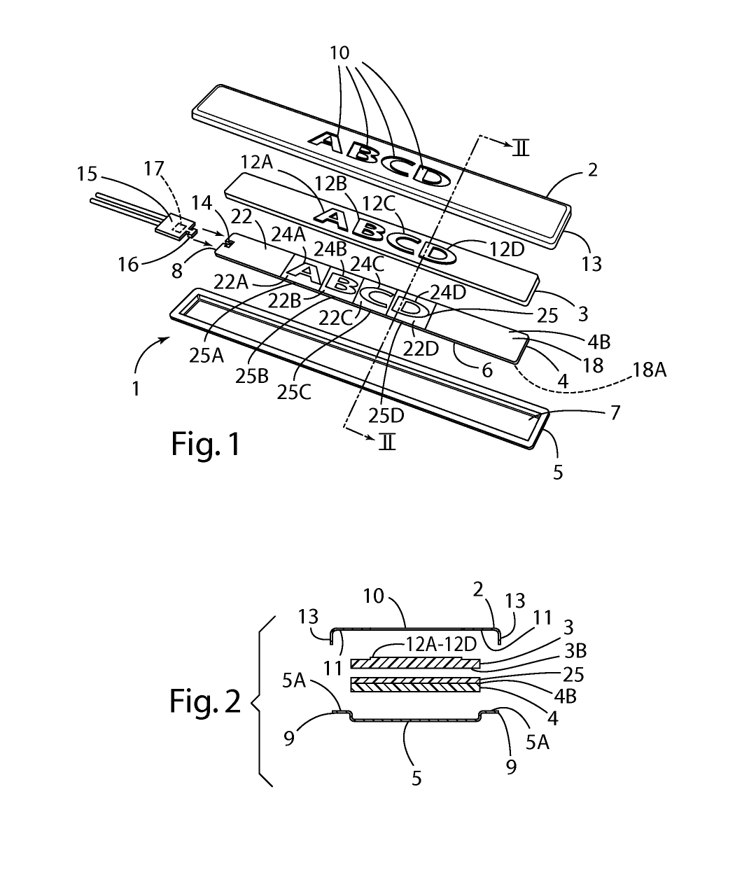

One aspect of the present invention is a lighted assembly or accessory unit for a motor vehicle. The assembly 1 (FIG. 1) may comprise a lighted door sill that includes an outer member 2 with cut outs or openings 10 forming letters, numbers, designs, or the like. Outer member 2 may be formed (e.g. stamped) from sheet metal utilizing known processes. Outer member 2 may also be fabricated from polymer materials utilizing molding or thermoforming processes. A lighted member 3 includes raised portions 12 forming letters, numbers, etc. that fit into openings 10 of outer member 2 when assembled. Member 3 may comprise a molded transparent or translucent thermoplastic polymer. A light source 15 may comprise one or more LEDs that are encapsulated in a thermoplastic polymer material as disclosed in U.S. Pat. No. 7,909,482 to Veenstra et al, issued Mar. 22, 2011 and/or U.S. Pat. No. 8,230,575, to Veenstra et al., issued Jul. 31, 2012 the entire contents of each being incorporated herein by reference. Light source 15 may be connected to light guide or pipe 4 utilizing light-transmitting adhesive and/or mechanical connectors 14 and 16 as disclosed in U.S. Pat. No. 7,712,933, the entire contents of which are incorporated by reference. Light guide 4 may comprise a sheet of transparent polymer material that is cut to form perimeter edge 6. End edge portion 8 may be cut to form a T-shaped female “puzzle piece” type connector 14 that interconnects with a T-shaped male connector 16 on LED light source 15 as described in U.S. Pat. No. 7,712,933. Upper and lower surfaces 18 and 18A of light guide 4 may be substantially smooth to internally reflect light from light source 15. Alternatively, the entire upper surface 18 may be treated utilizing a laser to form a rough surface that emits light that illuminates areas 12. Alternatively, only regions 24 may be treated to provide rough surface areas having shapes that are substantially identical to the shapes of openings 10 and raised portions 12. Regions 24 form illuminated areas that illuminate raised areas 12. Raised areas 12 protrude through openings 10, and are therefore visible, especially when illuminated. A backer member 5 has a “hat-shaped” profile (FIG. 2) forming a shallow cavity that receives members 3 and 4. Backer member 5 may be formed from sheet metal or polymer material. When assembled, adhesive/sealant on flanges 5A contacts the inner surface 11 of outer member 2 and/or the edge portions of members 2 and/or 3 to seal the cavity. Outer member 2 may include an outer flange 13 that extends past edges 9 of flanges 5A when assembled.

The light source 15 may include one or more LEDs 17. The LEDs may comprise white or other color LEDs. The LEDs 17 may comprise blue LEDs, and a layer of photo reactive/photoluminescent material 25 (FIG. 2) may be disposed on at least a portion of upper side 4B of light guide 4. The photo reactive material 25 may comprise an ink or other suitable coating material available from Performance Indicator, LLC of Lowell, Mass. The photo reactive materials may comprise fluorescent or phosphor based materials. It will be understood that various coating materials are available, and photo reactive material 25 may be mixed/selected as required for a particular application to emit light having a specific wavelength/color. As the light from LEDs 17 passes through the layer of material 25, some of the light is absorbed and light having a lower frequency is emitted by the material 25. The layer of material 25 may be configured such that some of the light from LEDs 17 passes through material 25 and remains at the original frequency. This light mixes with the lower frequency light emitted by material 25 to provide light having a desired color. For example, the material 25 may comprise a fluorescent ink having similar properties to the fluorescent material presently used in commercially available white LEDs. Commercially available “white” LEDs may comprise blue LEDs having a “YAG” (Yttrium Aluminum Garnet) phosphor coating that mixes down-converted yellow light with blue light to produce light that is substantially white. The photo reactive material 25 may comprise a YAG phosphor coating that is printed or otherwise deposited on surface 4B of light guide 4 to thereby mix with blue light from LEDs 17 to create white light that travels into lighted member 3 to thereby illuminate the raised portions 12. The photo reactive material 25 may be printed or otherwise deposited on an area 22 of surface 18 of light guide 4. Light from LEDs 17 travels inside light guide 4, and escapes at area 22 as a result of photo reactive material 25 being deposited on surface 18. Surface 18 does not necessarily need to be treated to form a rough surface to permit escape of light, and photo reactive material 25 may be printed or otherwise deposited directly on a smooth portion of surface 18. Alternatively, photo reactive material 25 may be deposited on surface 18 only at areas 24A-24D having shapes corresponding to raised areas 12 and openings 10.

Also, photo reactive materials 25A-25D having different light-emitting properties may be deposited at areas 22A-22D, respectively, or at areas 24A-24D, respectively. The photo reactive materials may be selected to emit different colors of light. For example, material 25A may emit red light, material 25B may emit green light, material 25C may emit yellow light, and material 25D may emit blue light. The light emitted from materials 25A-25D mixes with light (e.g. blue) from LED 17 to provide a desired color at raised portions 12.

The photo reactive material 25 (or 25A-25D) may alternatively be initially deposited on lower side surface 3B of lighted member 3, or the photo reactive material 25 may be preprinted on a thin layer of material (e.g. tape) that is adhesively secured to lighted member 3 or light guide 4. For example, photo reactive materials 25A-25D may be preprinted on large rolls of transparent thin polymer sheet material. The rolls of material may have adhesive disposed on one side thereof, or adhesive may be applied at the time the sheet material is adhered to lighted member 3 or light guide 4. If all of the raised areas 12A-12D are to have the same color, a single piece of the sheet having the shape of area 22 can be cut out and applied to lighted member 3 or light guide 4. Alternatively, individual pieces of material having shapes (e.g. letters) 24A-24D can be cut out and applied to lighted member 3 or light guide 4. If areas 12A-12D are to have different colors, pieces of sheet material with photo reactive materials 25A-25D can be cut to the shapes 22A-22D or the shapes 24A-24D, and the pieces can be applied to lighted member 3 or light guide 4.

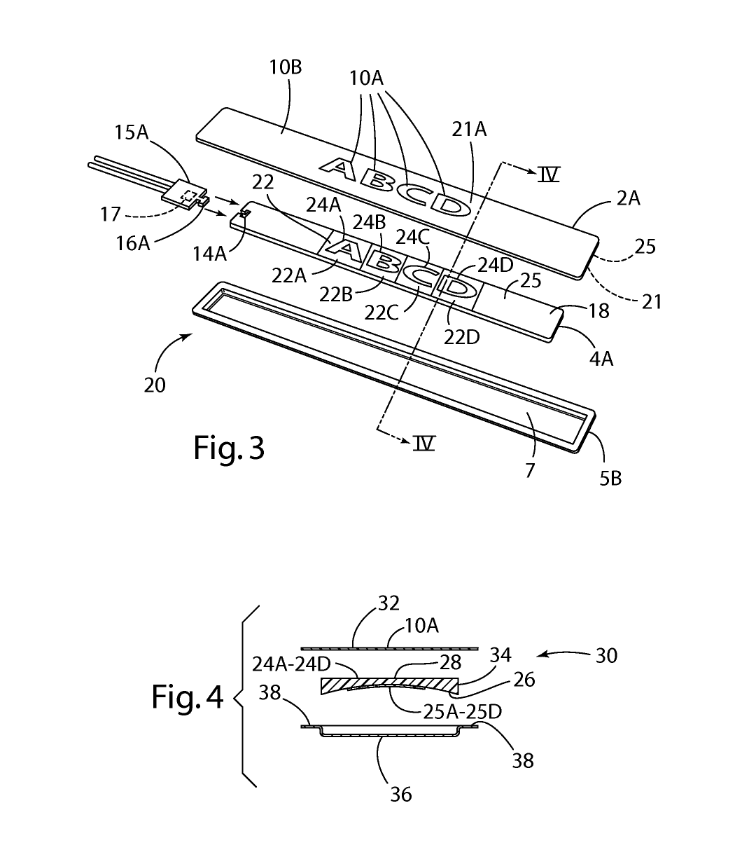

An illuminated assembly 20 according to another aspect of the present invention (FIG. 3) includes an appliqué 2A comprising a thin sheet of transparent polymer material having opaque ink printed on upper surface 21A and/or lower surface 21 thereof, except at regions 10A. Light therefore passes through regions 10A, but not the printed area 10B. Appliqué 2A may be adhesively secured to upper surface 18 of light guide 4A, and/or to flanges 5A of backer tub 5B. Regions 10A may alternatively comprise holes that are cut out to form letters, designs, etc. Light pipe 4A, light module 15A, and backer tub 5B may be substantially similar to the corresponding components shown in FIG. 1 and described above. Photo reactive material 25 (or 25A-25D) may be deposited on lower surface 21 of appliqué 2A or on upper surface 18 of light guide 4A to thereby generate light having the desired color that is emitted through regions 10A. One or more of the photo reactive materials 25A-25D may be printed/deposited directly onto the upper or lower surfaces of appliqué 2A or light guide 4A, or the photo reactive material may be disposed on tape or other suitable material that is cut to shapes 22A-22D and/or 24A-24D and adhered to the upper or lower surfaces of appliqué 2A and/or light guide 4A.

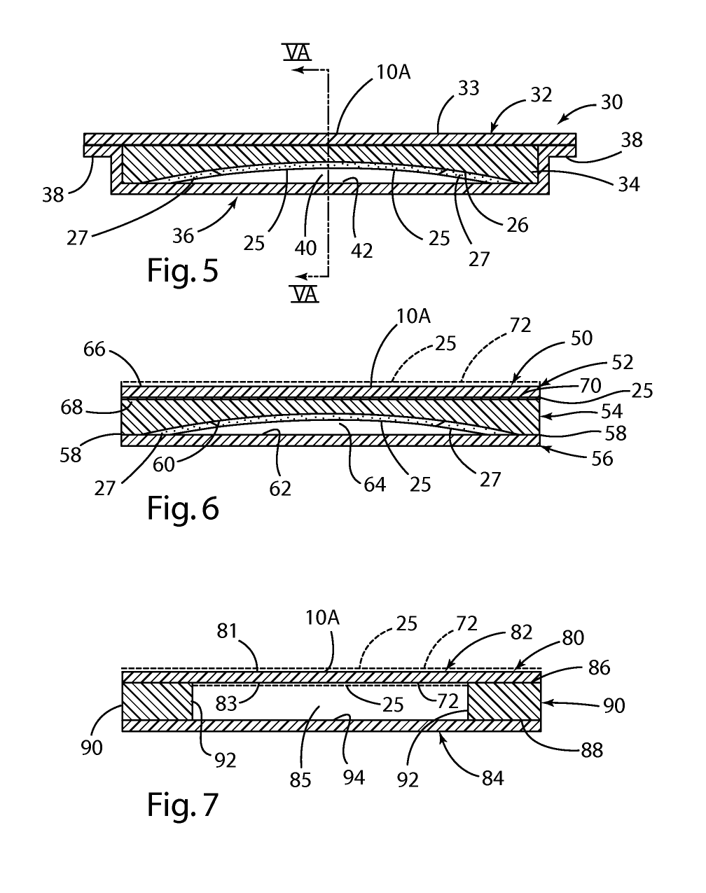

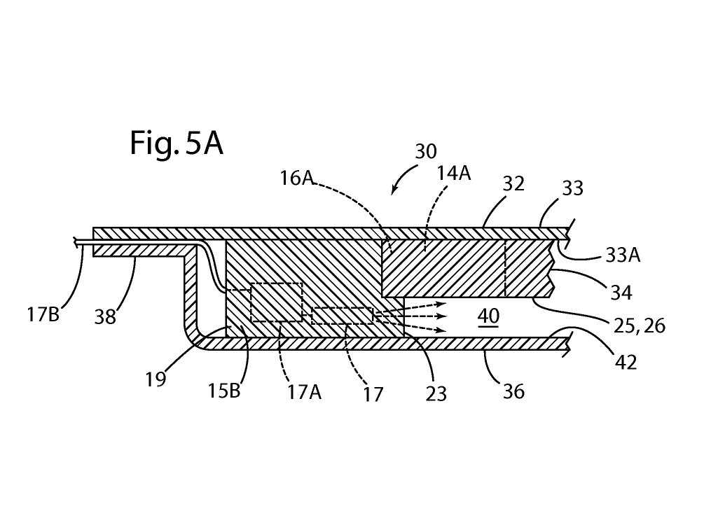

With further to FIGS. 4 and 5, a light assembly 30 according to another aspect of the present invention includes a molded polymer member 34 having a concave lower surface 26 and a substantially flat upper surface 28. The member 34 may include connectors 14A (FIG. 5A) that connect the light guide 34 to a light engine 15B having one or more LEDs 17 in substantially the same manner as described in more detail above in connection with FIGS. 1 and 3. LEDs 17 of light engine 15B may be blue LEDs that can be utilized to provide illuminated areas 24A-24D having the desired colors. Light engine 15B (FIG. 5A) includes a transparent polymer body 19 having one or more LEDs 17 and associated electrical circuit elements 17A disposed therein. Electrical lines 17B provide power to the circuit elements 17A and LEDs 17. Lower surface 26 of member 34 is spaced apart from surface 42 of backing member 36 to form a space or gap 40 that extends along the length of member 34 (member 34 may have an elongated shape similar to light guides 4, 4A, etc.). One or more LEDs 17 are positioned adjacent side surface 23 of body 19 such that light from LEDs 17 is emitted into space 40. Body 19 may include a connector 16A that connects to a connector 14A of member 34 in substantially the same manner as described above in connection with FIG. 3. Upper surface 28 of member 34 may optionally include light emitting areas 24 having a rough surface formed by laser treatment or other suitable process. Alternatively, the entire upper surface 28 may be a rough surface that emits light, or the entire upper surface 28 may be smooth. The assembly 30 includes an outer member 32 that may be substantially the same as the appliqué 2A described in more detail above in connection with FIG. 3. The outer member 32 may be adhesively secured to flanges 38 of backer member 36.

Interior surface 42 of backing member 36 may comprise a reflective surface (e.g. white) such that space 40 forms a light guide whereby light from LEDs 17 is reflected internally. The blue light from LEDs 17 is thereby distributed along the lower surface 26 of light guide 34. Lower surface 26 of member 34 may be coated with one or more photo reactive materials 25A-25D such that light in space 40 causes material 25 to emit lower frequency light that is emitted from upper surface 28 of member 34. Some of the light from LEDs 17 passes through photo reactive material 25 and mixes with light from LEDs 17, and is emitted from surface 28 and travels through transparent areas 10A of cover 32. The entire surface 26 of member 34 may be coated with photo reactive material 25. Alternatively, a layer 27 of ink or other suitable opaque/reflective material may be disposed on portions of surface 26 to internally reflect light. Photo reactive materials 25A-25D may be deposited (e.g. printed) directly on surface 26, or the photo reactive materials 25A-25D may be preprinted on tape or other suitable material that is adhesively secured to surface 26 through photo reactive material 25, through member 34, and through openings or transparent regions 10A of cover 32. Upper surface 33 or lower surface 33A of cover 32 may be coated with an opaque ink or other material except in the regions of letters or areas 10A, and the cover 32 may comprise a substantially transparent polymer material. Thus, the regions 10A are illuminated by light from LEDs 17 and photo reactive material 25.

With further reference to FIG. 6, a lighted assembly 50 according to another aspect of the present invention includes a cover or appliqué 52, a molded polymer member 54, and a backer member 56 having an upper surface 62 that is preferably reflective. The molded polymer member 54 may be made from transparent polymer or the like. The backer member 56 may comprise a sheet of substantially flat polymer material that is adhesively bonded to molded polymer member 54 at joints 58. Molded polymer member 54 includes a curved lower surface 60 that is spaced apart from upper surface 62 of backer member 56 to define a gap or space 64. A light engine 15B (FIG. 5A) may be utilized to direct light from one or more LEDs into space 64. The cover 52 includes upper and lower surfaces 66 and 68, respectively. Lower surface 68 of cover 52 may be adhesively bonded to upper surface 70 of molded polymer member 54. A layer of photo reactive material 25 may be disposed between the lower surface 68 of cover 52 and upper surface 70 of polymer member 54. Alternatively, photo reactive material 25 may be disposed on upper surface 66 of cover 52. The photo reactive material 25 may be disposed only in the regions 10A, and an opaque ink material or the like may be utilized to cover the other portions of upper surface 66 of cover 52. Alternatively, photo reactive material(s) 25A-25D and reflective material 27 may be disposed on lower surface 60 of member 54. The photo reactive material may be deposited directly onto one of cover 52 and member 54, or the photo reactive material may be preprinted onto sheets of material that are adhesively attached to cover 52 or member 54.

A light engine 15B (FIG. 5A) may be connected to molded polymer member 54 and/or cover 52 and/or backer member 56 to thereby direct light (e.g. blue light) from LED 17 into the space 64. Light from the LEDs 17 travels through the space 64, through the photo reactive material 25, through the molded polymer member 54, and through areas 10A to thereby illuminate the areas 10A.

With further reference to FIG. 7, an assembly 80 according to another aspect of the present invention includes a transparent polymer cover 82 and a backing member 84 that are adhesively secured to opposite side faces 86 and 88 of a polymer member 90. Inner surfaces 92 of polymer member 90 (see also FIG. 11) and inner surface 94 of backing member 84 may be reflective (e.g. coated with white ink) to thereby guide light from LEDs 17 through gap 85. Upper and/lower surfaces 83 of cover member 82 may be at least partially coated with photo reactive material 25 (or materials 25A-25D) such that light emitted through areas 10A is substantially white or other desired color. Opaque ink 72 or other material may be disposed on upper and/or lower surfaces 81 and 83 of cover 82 to thereby block light except in the regions 10A. Member 90 may have a ring-like shape (FIG. 11), and a light engine 15 may be connected to member 90 utilizing connectors 14 and 16 (FIG. 1).

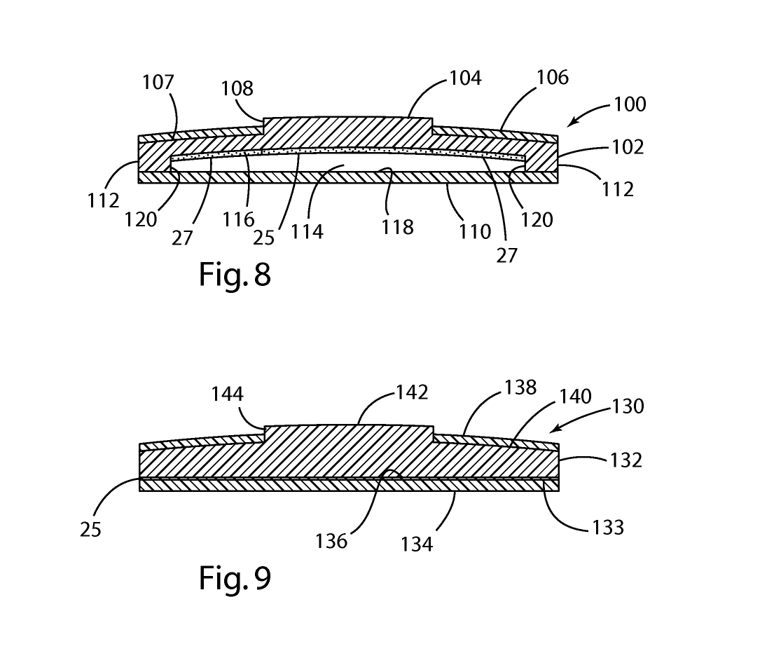

With further reference to FIG. 8, a light assembly 100 according to another aspect of the present invention includes a molded polymer member 102 that may be made from transparent polymer or the like. The molded polymer member 102 includes raised areas 104 that may form letters or other shapes. A formed metal cover 106 covers upper surface 107 of molded polymer member 102. The formed metal component 106 may include openings 108, and the raised areas 104 of molded polymer member 102 may protrude through the openings 108. A polymer backing member 110 may be adhesively secured to side portions 112 of molded polymer member 102 to form an elongated channel or space 114 that receives light from LEDs 17 as described above in connection with FIG. 5A. Photo reactive material 25 and/or 25A-25D may be disposed on the curved lower surface 116 of molded polymer member 102 such that blue light from LEDs 17 mixes with lower frequency light emitted by coating 25 prior to being emitted through raised areas 104. Inner surface 118 of backing member 110 may comprise a reflective (e.g. white) surface, and inner surfaces 120 of polymer member 102 may also comprise reflective surfaces. Opaque/reflective material 27 may be disposed on lower surface 116 of member 102 below cover 106. Photo reactive materials 25, 25A-25D may be printed on surface 116 or preprinted on tape that is adhesively applied to lower surface 116.

With further reference to FIG. 9, a lighted assembly 130 according to another aspect of the present invention includes a molded polymer member 132 having a generally planar lower surface 133. A backing member 134 may be adhesively secured to lower surface 133 of molded polymer member 132. Molded polymer member 132 may comprise a transparent or other light-transmitting polymer material, and backing member 134 may comprise opaque polymer or other suitable material. A layer of photo reactive material 25 may be disposed between upper surface 136 of backing member 134 and lower surface 133 of molded polymer member 132. A formed metal member 138 extends over upper surface 140 of molded polymer member 132. Molded polymer member 132 may include raised areas 142 that extend through openings 144 in formed metal member 138. Molded polymer member 132 may include an integrally molded connector 14 (FIG. 1) that connects to a connector 16 of a light engine 15 to thereby provide blue light from LEDs 17. As the light travels through the molded polymer member 132, some of the light reflects internally from the photo reactive material 25, and some of the light causes photo reactive material 25 to emit lower frequency light into member 132. The two frequencies of light mix to produce light having the desired color. The missed light is emitted through raised portions 142. Raised portions 142 may form letters or other designs.

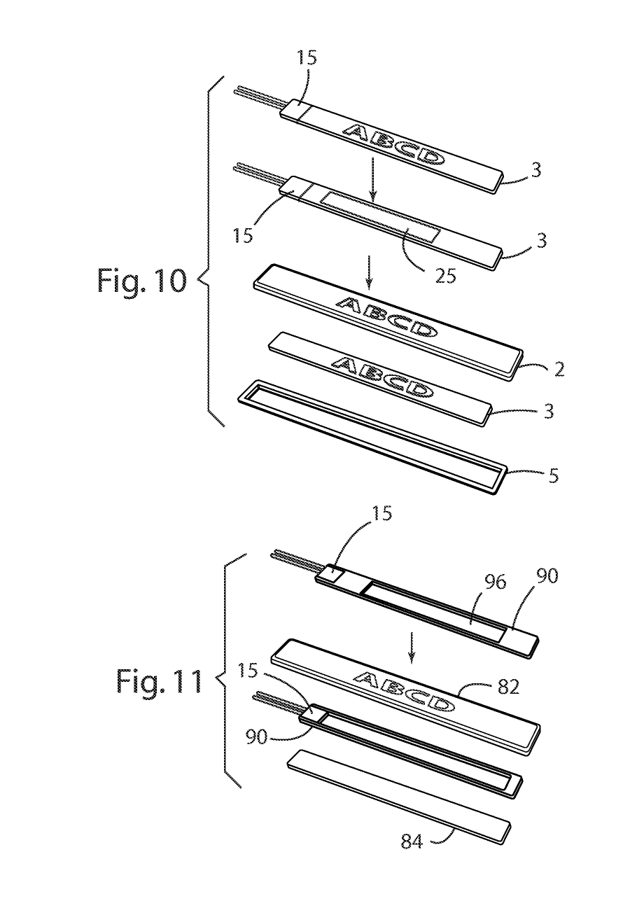

With further reference to FIG. 10, during fabrication of the light assemblies 1, 20, 30, 50, 100, and 130, the polymer member 3, 4A, 34, 54, 102, or 132 is first molded, and a light engine 15 (or 15B) is connected to the polymer member. Fluorescent material 25 is then deposited on the polymer member, and the polymer member 3 is then assembled with an outer member 2 and backing member 5. The polymer member designated “3” in FIG. 10 may comprise any of the polymer members described above in connection with FIGS. 1-9, and the cover member designated “2” in FIG. 10 may comprise any of the formed metal members described in more detail above in connection with FIGS. 1-9. Similarly, backing member 5 may comprise any one of the backing members described in more detail above in connection with FIGS. 1-9.

With further reference to FIG. 11, fabrication of assembly 90 (see also FIG. 7) includes molding a polymer member 90 having a central opening 96. A light engine 15 is connected to the polymer member 90, and cover 82 and backing member 84 are adhesively secured to the polymer member 90.

The processes for forming illuminated assemblies 1 and 20 are shown in FIG. 3. As shown in FIG. 3, a light source 15 may be operably connected to a ring-like light pipe 40 having a central opening 42.

Although an illuminated sill assembly is shown, it will be understood that the same constructions described above may be utilized to form lighted badges, signs, etc.

These and other features, advantages, and objects of the present invention will be further understood and appreciated by those skilled in the art by reference to the following appended drawings.

What is claimed is:

1. A lighted assembly comprising:
an LED that emits light having a first frequency;
an elongated light transmitting assembly defining inner and outer sides, wherein the outer side defines at least one illuminated area having a predefined shape, and a non-illuminated area surrounding the illuminated area, the elongated light transmitting assembly including a cover member on the outer side, a backing member on the inner side, and an intermediate member disposed between the cover member and the backing member, wherein the LED is optically connected to the elongated light transmitting assembly whereby light from the LED is transmitted along an optical path defined by the elongated light transmitting assembly to the illuminated area; and
a layer of photo reactive material disposed along the optical path, wherein the photo reactive material produces light having a second frequency that is less than the first frequency that mixes with the light at the first frequency to thereby produce light having a desired color that is emitted from the illuminated area.

2. The lighted assembly of claim 1, wherein:
the intermediate member comprises an elongated substantially transparent polymer member that is connected to the LED whereby light from the LED is transmitted internally along the intermediate member.

3. The lighted assembly of claim 2, wherein:
the elongated polymer member defines inner and outer surfaces and the photo reactive material comprises a layer disposed adjacent at least one of the inner and outer surfaces.

4. The lighted assembly of claim 3, wherein:
the layer of photo reactive material is disposed on a surface of the backing member facing the intermediate member.

5. The lighted assembly of claim 4, wherein:
the cover member comprises metal having openings therethrough forming the illuminated area.

6. The lighted assembly of claim 5, wherein:
the cover member is formed from sheet metal having a substantially uniform thickness.

7. The lighted assembly of claim 5, wherein:
the elongated polymer member includes raised areas on the outer surface that extend through the openings in the cover member.

8. The lighted assembly of claim 5, wherein:
the inner surface of the elongated polymer member is substantially planar; and
the backing member comprises a flat sheet of polymer material extending over the inner surface of the elongated polymer member.

9. The lighted assembly of claim 8, wherein:
the backing member is adhesively secured to the elongated polymer member.

10. The lighted assembly of claim 3, wherein:
the layer of photo reactive material is disposed on a side of the cover member facing the intermediate member.

11. The lighted assembly of claim 1, wherein:
the elongated light transmitting assembly defines an elongated internal space; and
the LED is configured to project light into the elongated internal space.

12. The lighted assembly of claim 11, wherein:
the intermediate member comprises a molded polymer member having an inner surface defining an elongated channel that is closed off by the backing member to form the elongated internal space.

13. The lighted assembly of claim 12, wherein:
the layer of photo reactive material is disposed on the inner surface.

14. A lighted assembly, comprising:
an LED light source providing light at a first frequency;
a member comprising a light-transmitting material, the member including at least first and second areas having layers of first and second photo reactive materials extending over the first and second areas, wherein the LED light source is optically coupled to the first and second areas whereby light from the LED light source at the first frequency is received by the first and second photo reactive materials, and wherein the first photo reactive material emits light at a second frequency that is lower than the first frequency, and wherein the second photo reactive material emits light at a third frequency that is lower than the first and second frequencies whereby the first and second areas emit light having two different colors.

15. The light assembly of claim 14, wherein:
the first and second materials are disposed on an outer surface of the light-transmitting material.

16. The light assembly of claim 15, wherein:
light at the first frequency from the LED light source propagates through the light-transmitting material and is incident on the first and second photo reactive materials, causing the first and second photo reactive materials to emit light at the second and third frequencies, respectively.

17. The light assembly of claim 16, wherein:
light is emitted by the first and second photo reactive materials away from the outer surface of the light transmitting material.

18. The light assembly of claim 15, wherein:
the lighted assembly includes an elongated space forming a light guide that receives light from the LED light source, and wherein the first and second materials face the elongated space whereby light from the LED incident on the first and second photo reactive materials causes first and second photo reactive materials to emit light having the second and third frequencies into the light-transmitting material.

19. A method of fabricating a lighted assembly, comprising:
providing an LED light source that emits light having a first frequency;
providing an elongated light guide;
operably connecting the LED light source to the light guide such that light at the first frequency travels along the elongated light guide;
providing a photo reactive material along the light guide whereby light at the first frequency is incident on the photo reactive material and causes the photo reactive material to emit light at a second frequency that is significantly less than the first frequency.

20. The method of claim 19, including:
providing a second photo reactive material along the light guide that receives light at the first frequency and emits light at a third frequency that is significantly lower than the first and second frequencies.

21. The method of claim 19, wherein:
providing an elongated light guide includes forming an elongated space; and including:
directing light from the LED into the elongated space.

22. The method of claim 19, wherein:
providing an elongated light guide includes forming an elongated member from a light transmitting polymer material; and including:
directing light from the LED into the light transmitting polymer material of the elongated member.
